(19) United States
(12) Patent Application Publication
(10) Pub. No.: US 2026/0340500 A1
(43) Pub. Date: Oct. 29, 2026

(54) Deterministic Prompt-Level Control Plane with Reserved Instruction Vocabulary and Dual-Guardrail Clarity Enforcement for Artificial Intelligence Systems

(71) Applicant: Gregg Dotoli, Long Neck, DE (US)

(72) Inventor: Gregg Dotoli, Long Neck, DE (US)

(21) Appl. No.: 19/533,219

(22) Filed: Feb. 8, 2026

(51) Int. Cl. G06N 20/00

(52) U.S. Cl. CPC G06N 20/00

(57) ABSTRACT

A deterministic prompt-level control plane for artificial intelligence systems is disclosed. A delimited control region containing reserved instruction tokens is parsed independently of natural language content. Parsed instructions are reduced into an effective policy that governs permitted actions, preventing prompt injection, ambiguity, and instruction drift.

### TECHNICAL FIELD

The present disclosure relates generally to artificial intelligence systems and, more particularly, to prompt-level control, authorization, and security enforcement mechanisms for large language models, autonomous agents, and artificial intelligence systems capable of executing actions or invoking tools.

### BACKGROUND

Artificial intelligence systems increasingly perform tasks with real-world effects. Existing control approaches rely on natural language interpretation, heuristic moderation, or post-hoc detection of malicious intent. Such approaches are inherently ambiguous and susceptible to manipulation, prompting a need for deterministic and enforceable control mechanisms.

### SUMMARY

Disclosed herein is a deterministic prompt-level control plane that separates authority from natural language by using a reserved instruction vocabulary parsed from a designated control region of a prompt. Parsed instructions are reduced into an effective policy that governs permitted actions, while narrative content is treated as non-authoritative data.

### DETAILED DESCRIPTION

In one embodiment, a prompt includes a control lane and a data lane. The control lane is explicitly delimited and parsed using a finite vocabulary of reserved tokens. The resulting policy is enforced as a primary guardrail. A secondary guardrail may analyze data content for risk signals without granting authority.

1. A computer-implemented system for controlling actions of an artificial intelligence model, comprising: a prompt receiver; a control parser configured to identify a delimited control region; a reserved instruction interpreter configured to parse the control region using a finite vocabulary of predefined tokens; a policy reducer configured to generate an effective policy using deterministic conflict resolution; and an enforcement module configured to permit or deny execution of actions based on the effective policy, wherein natural language outside the control region is treated as non-authoritative data.

2. The system of claim 1, wherein execution is denied by default unless explicitly permitted by the effective policy.

3. The system of claim 1, further comprising a secondary analysis module configured to evaluate non-authoritative data for risk indicators without granting execution authority.

4. A computer-implemented method comprising receiving an input prompt, extracting a control region using explicit delimiters, parsing the control region using a reserved instruction vocabulary, reducing parsed instructions into an effective policy, and enforcing the policy prior to executing any action.

5. A non-transitory computer-readable medium storing instructions that, when executed, cause performance of the method of claim 4.
